(19) United States
(12) Patent Application Publication
(10) Pub. No.: US 2004/0052521 A1
(43) Pub. Date: Mar. 18, 2004

(54) Diagnostic monitoring system for WDM networks

(76) Inventors: Ross Halgren, Collaroy Plateau (AU); Brian Robert Brown, Collaroy (AU); Scott Calder, Sutherland (AU); Iain Waugh, Five Dock (AU); Quentin Scott, Pymble (AU)

Correspondence Address: CHRISTIE, PARKER & HALE, LLP, 350 WEST COLORADO BOULEVARD, SUITE 500, PASADENA, CA, 91105, US

(21) Appl. No.: 10/122,143

(22) Filed: Apr. 12, 2002

(51) Int. Cl. H04B 10/08; H04J 14/02

(52) U.S. Cl. 398/19; 398/12; 398/34

(57) ABSTRACT

A diagnostic monitoring system for a WDM network, the system comprising an electrical non-blocking cross-connect switch having a plurality of demultiplexer ports, a plurality of multiplexer ports, at least one tributary receiver port, at least one tributary transmitter port, and at least one diagnostic port; and at least one multi-protocol performance monitoring unit connected to one of said at least one diagnostic ports such that said at least one multi-protocol performance monitoring unit, in use, can selectively monitor one of said demultiplexer or tributary receiver ports whereby said system, in use, supports multi-protocol intrusive monitoring of a test signal and multi-protocol non-intrusive monitoring of live traffic at said at least one demultiplexer or tributary receiver port

### FIELD OF THE INVENTION

This invention broadly relates to diagnostic monitoring of WDM networks. The invention is particularly applicable in a 3R regenerative network and more particularly in an add/drop node or terminating node of a 3R regenerative network though it is not intended that the invention shall be limited thereto.

### BACKGROUND OF THE INVENTION

Optical wavelength division multiplexing (WDM) networks are being developed to support a variety of transmission protocols. These multi-protocol networks give rise to network management and diagnostic issues that have not been addressed in the prior art.

Optical wavelength division multiplexing (WDM) networks require testing before they are provisioned and hand-off to a customer or user.

Additionally, once individual channels or paths (comprising multiple channels) are provisioned as an end-end connection and customer traffic is using this connection, it is desirable to conduct continuous “performance monitoring” of the channels and paths to confirm that a required quality of service is provided and to assist in identifying the likely location of faults as or before faults arise.

In at least preferred embodiments, the present invention seeks to provide a diagnostic monitoring system for a WDM network which can address the general needs of monitoring WDM channels both in the absence of customer traffic and during transmission of customer traffic.

### SUMMARY OF THE INVENTION

Throughout this specification and in the claims, the term “intrusive monitoring” is used to refer to a form of testing in the absence of customer traffic on a particular WDM channel or path, i.e. utilising a dedicated test signal fed into the relevant channel or path and monitoring the test signal after transmission through the relevant channel or path. Furthermore, the term “non-intrusive monitoring” is used to refer to a form of diagnostic monitoring conducted on the customer traffic signal as opposed to a dedicated test signal, and without interfering with the data content of the customer traffic data signal.

In a first aspect, the present invention provides a diagnostic monitoring system for a WDM network, the system comprising:

an electrical non-blocking cross-connect switch having a plurality of demultiplexer ports, a plurality of multiplexer ports, at least one tributary receiver port, at least one tributary transmitter port, and at least one diagnostic port; and

at least one multi-protocol performance monitoring unit connected to one of said at least one diagnostic ports such that said at least one multi-protocol performance monitoring unit, in use, can selectively monitor one of said demultiplexer or tributary receiver ports;

whereby said system, in use, supports multi-protocol intrusive monitoring of a test signal and multi-protocol non-intrusive monitoring of live traffic at said at least one demultiplexer or tributary receiver port.

In a preferred embodiment, the system comprises a group of multi-protocol performance monitoring units each connected to one of the diagnostic ports of said switch such that the multi-protocol performance monitoring units can monitor a plurality of demultiplexer and/or tributary receiver ports.

Preferably, said multi-protocol performance monitoring unit comprises a programmable clock and data retiming (CDR) element and a programmable multi-protocol monitor. Preferably a programmable multi-protocol monitor comprises at least one of Gigabit Ethernet, Fibre Channel or SONET OC-n protocol monitors.

Advantageously, said programmable multi-protocol monitor comprises a programmable line decoder and a programmable performance analyser for non-intrusive performance monitoring of live customer traffic. In a further preferred embodiment, the multi-protocol monitoring unit further comprises a pattern decoder and error counter element, and is arranged, in use, such that the line decoder can be selectively bypassed for intrusive performance monitoring utilising the pattern decoder and error counter element.

In one embodiment, the system further comprises at least one programmable test signal generator unit connected to one of said diagnostic ports, such that said at least one test signal generator unit can input a test signal at one of said multiplexer or tributary transmitter ports for intrusive performance monitoring. Preferably, the switch is arranged, in use, to support multi-cast of said one test signal to at least two of said multiplexer and/or tributary transmitter ports.

Said programmable test signal generator unit may comprise a programmable line encoder for encoding said test signal. The line encoder may be arranged such that it is by-passable.

In accordance with the second aspect of the present invention, there is provided a WDM network node comprising a diagnostic monitoring system as defined in the first aspect.

Preferably, the WDM network node is arranged as a Optical-Electrical-Optical (OBO) WDM add/drop multiplexer or terminal multiplexer node, and the electrical non-blocking cross-connect switch of the diagnostic monitoring system is disposed such that, in use, switching of the WDM channel signals is effected through said electrical non-blocking cross-connect switch of the diagnostic monitoring system.

In one embodiment, the OEO WDM add/drop multiplexer or terminal multiplexer node comprises 3R regeneration.

### BRIEF DESCRIPTION OF THE DRAWINGS

The invention will now be described by way of example only with reference to preferred embodiments and to the accompanying figures in which:—

FIG. 1 is a schematic diagram of an OEO WDM bi-directional ring network embodying the present invention;

FIG. 2 is a schematic diagram of a network node embodying the present invention;

FIG. 3 is a schematic diagram of a multi-protocol performance monitoring unit and test signal generator embodying the present invention.

### DETAILED DESCRIPTION OF THE EMBODIMENTS

In contrast to single-protocol regenerative networks such as: Synchronous Optical Network (SONET); Synchronous Digital Hierarchy (SDH), Fibre Distributed Data Interface (FDDI) and Resilient Packet Ring (RPR), WDM networks generally support multiple protocols and thus require multi-protocol testing and performance monitoring to confirm their operation under all conditions. Single-protocol regenerative networks only require a single test solution.

Optical networks, in particular 3R regenerative WDM networks, can have inline failure modes due to active device failures. For example, in order to achieve high availability, 3R networks require backup paths, path protection switching, test signal injection and performance monitoring of test signals for all unused paths and channels. To support multiple protocols, both the test signals and the test signal error checking (performance monitoring) are configurable to simulate data patterns and data rates representative of each protocol, in the preferred embodiments described.

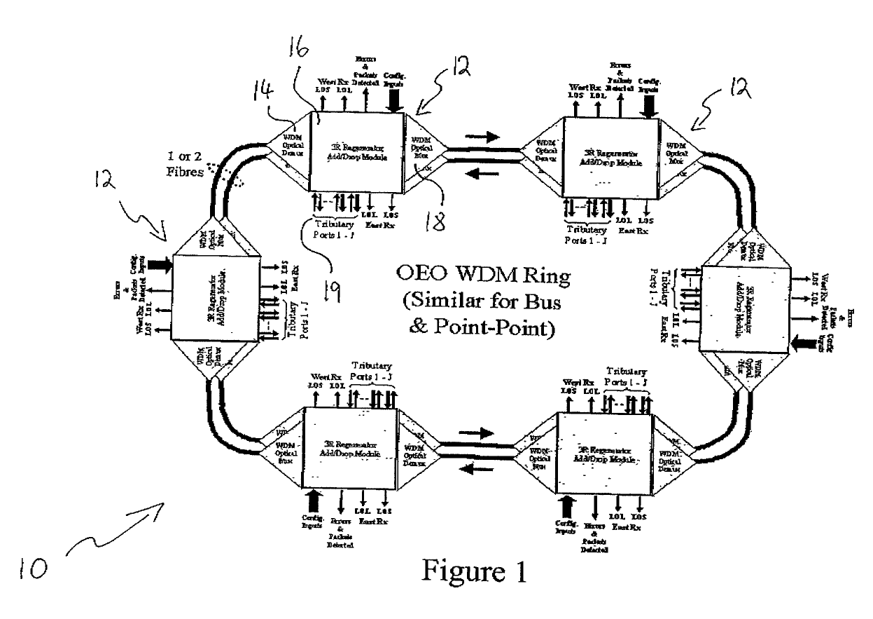

Referring to FIG. 1 there is shown schematically an OBO WDM bi-directional ring network 10 having a plurality of network nodes 12. Each network node 12 comprises optical WDM demultiplexer 14, a 3R regenerator add/drop module 16 and WDM optical multiplexer 18 for each direction. The node 12 further comprises tributary ports 19 for connection to customer interfaces.

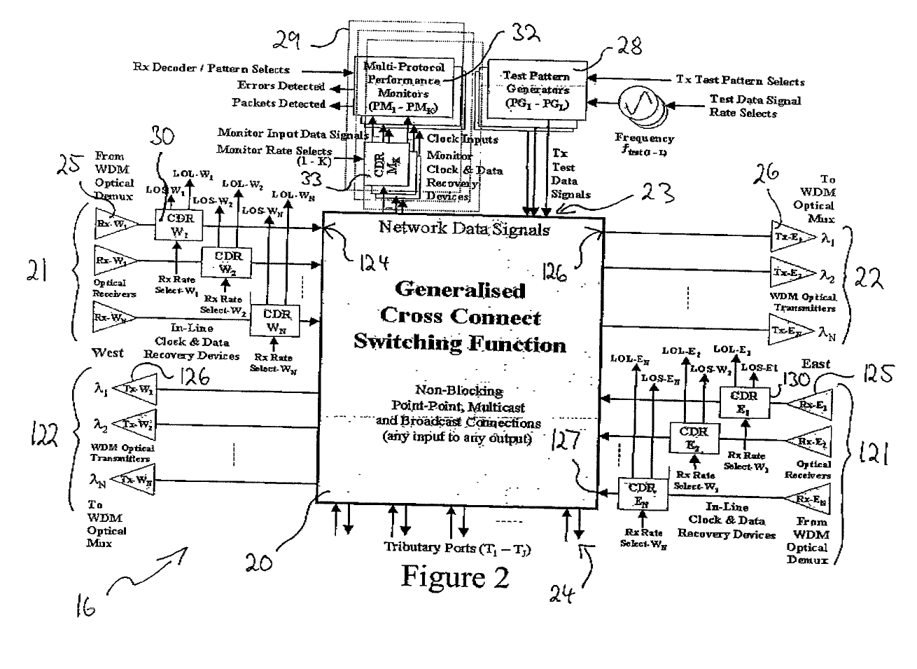

The functional elements and interfaces of an WDM add/drop module 16 in accordance with a preferred embodiment of the invention are shown in FIG. 2. The interfaces includes a WDM receive interface 21, a WDM transmit interface 22 for west-east traffic, and a WDM receive interface 121, and a WDM transmit interface 122 for east-west traffic. An electrical non-blocking cross-connect switch 20 is disposed between the west WDM receive-transmit interfaces 21, 122 and the east WDM transmit/receive interfaces 22, 121 respectively, with the connection to the switch 20 at a plurality of demultiplexer and multiplexer ports e.g. 124 and 126 respectively.

The switch 20 further has a plurality of test ports 23, and also tributary ports 24 for interfacing to customer equipment. Specifically, FIG. 2 illustrates N-West Optical Receivers 25 which are connected to a West WDM Demultiplexer element (not shown) and N-East Optical Transmitters 26 which are connected to a East WDM Multiplexer element (not shown).

Similarly, N-East Optical Receivers 125 are connected to a East WDM Demultiplexer element (not shown) and N-West Optical Transmitters 126 are connected to a West WDM multiplexer element (not shown). On both the west and the east WDM transmit interface 22, 122, the individual transmitters each transmit a different wavelength (λ₁-λ_{N}). The optical receivers 25, 125 are broadband and can receive any wavelength. The WDM Demultiplexers elements, (not shown) determine which wavelength goes to which receiver.

Connected to the test ports 23 are a plurality of test patten generators 28 and multi-protocol performance monitoring units 29 as will be described in greater detail below.

The non-blocking cross-connect switch 20 has broadcast and multicast capabilities as is known.

The optical receivers 25, 125 connect to the switch 20 through clock and data retiming (CDR) elements 30, 130. For a WDM network, each wavelength may transport a different protocol and data rate. The allocation of protocols and data rates to wavelengths is not fixed—it can vary with time due to changing customer connections. To retime each received signal therefore requires a programmable multi-rate Clock & Data Recovery (CDR) element 30, 130. Each CDR 30, 130 has a Rx Rate Select configuration input. In the example embodiment, a micro-controller sets the rate required under a Network Management control. This occurs at connection establishment. A default or programmable test rate is selected for monitoring the channel in the absence of customer traffic.

Each Optical Receiver 25, 125 and CDR element 30, 130 provides a basic performance monitoring function including Loss of Signal (LOS) and Loss of Lock (LOL). Further details of LOS and LOL monitoring are described in the co-pending US patent application entitled “Path protection in WDM network”, filed on Feb. 7, 2001 and assigned to the assignee of the present application, the contents of which are incorporated herein by reference.

The basic performance monitoring function provided by the LOS and LOL status signals cannot function without first injecting either customer (user) data or a test signal. In the absence of user data, each channel in a OEO network can be exercised with a suitable test signal so that the active network elements that provide that channel are tested to confirmed to be operational. If this continual testing is not performed, then there is a possibility that failures will accumulate with time (latent failures) and when a path or channel is to be provisioned or used for protection purposes, it may not be working when user data is connected, Thus the network availability is reduced. All-Optical networks have this problem to a lesser extent, since many of the network elements between multiplexers are passive and are not likely to fail. The electronics within the multiplexer can fail however, and the example embodiment enables such multiplexer channels and functional elements to be tested as well.

A DC optical test signal and the LOS status would be adequate for testing fibre continuity, however, more qualified testing of the path and channel enabled by the example embodiment requires high-speed test data to be sent over the channel and the test data pattern and rate should match the protocols and data rates to be supported by each channel. Since each WDM channel may need to support any protocol and data rate, then it should be possible to inject test signals onto any wavelength channel that can fully exercise the range of conditions that the channel would need to support (maximum/minimum clock rates and maximum number of consecutive identical digits for example). Diagnostic monitoring will be described in greater detail below.

The test pattern generators 28 inject test signals into the system through the test ports 23 of the switch 20. A range of test rates and patterns may be configured to emulate different protocols. Examples include 2²³-1 and 2⁷-1 Pseudo Random Bit Sequence (PRBS) patterns, 101010 (on-off) patterns and pre-programmed patterns (eg 1100011000 etc). For example, a 200 Mbit/s 8B/10B encoded ESCON tributary interface may not necessarily work if tested with a 200 Mbit/s 2²³-1 PRBS test pattern. This is because the number of consecutive identical digits in such a pattern (23) may significantly degrade the performance, given that the 8B/10B line code only has a maximum of five consecutive identical digits. AC-coupling capacitors on the tributary interface may not have been designed for such long strings of 1 s or 0 s for example. A simple test pattern generator for normal 8B/10B coded tributary signals might comprise a simple N×10-bit (eg 20-bit) test pattern that is repeated.

Multiple test pattern generators 28 are provided so that different channels and tributary interfaces can be tested simultaneously with test patterns and rates that are supported by these channels and tributary interfaces. This is preferred because whilst WDM channels should support any protocol and rate, the tributary interfaces themselves may be optimized for a smaller range of protocols and rates and thus it may not always be possible to broadcast or multi-cast the same test signal to all devices to be tested simultaneously. If loop-back testing of multiple tributary interfaces of different types is required to be undertaken substantially continuously until such time that the tributary interfaces and channels are provisioned or connected, then multiple test generators 28 with different patterns and rates are required, as shown in the example embodiment. Each of the test generators 28 is programmable to match the characteristics of the channel or tributary interface to be tested.

In the example embodiment shown in FIG. 2, a plurality of multi-protocol performance monitoring units 29 is provided. Each unit 29 comprises a multi-protocol performance monitor 32 and a programmable monitor CDR 33. The monitor CDR 33 is configured or configurable for the required data rate.

For intrusive monitoring of injected test patterns, the multi-protocol performance monitor 32 and associated input CDR 33 rate is matched to the test signal input to the network so that bit errors can be detected and counted.

The multi-protocol performance monitors 32 can not only detect errors in the pseudo random and fixed-sequence test patterns from the test generators, but they can also detect errors in live traffic that is transmitted by a customer. The multi-Protocol performance monitors 32 can thus be used for both intrusive and non-intrusive testing.

Examples of Multi-Protocol Performance Monitors are Gigabit Ethernet, Fibre Channel and SONET OC-n protocol monitors.

In the case of SONET OC-n monitors, the frame header bits are demultiplexed to reveal the Section bit interleaved parity code (BIP-8) byte. This is a parity code (even parity) used to check for transmission errors over a regenerator section. Its value is calculated over all bits of the previous STS-N fibre after scrambling, then placed in the B1 byte of STS-1 before scrambling.

In the case of Gigabit Ethernet and Fibre Channel monitors, the multi-protocol performance monitors can simply look for code violations in the 8B/10B line code that both protocols employ. The performance monitors may also look for ran length disparity between the number of ones and zeros in a data stream. A run length disparity error is identified by comparing the number of unbalanced code words weighted with more ones than zeros to the number of unbalanced code words weighted with more zeros than ones. Additionally, the monitors can look for the 10-bit code word corresponding to the packet delimiter to determine the packet rate. Further processing of packet bytes can be used to identify packet Cyclic Redundancy Check (CRC) errors and thus the packet error rate.

If needed, the multi-protocol performance monitors 32 may each include additional performance monitors for other common protocols, such as 4B/5B, Manchester and Bi-Phase Mark or Bi-Phase Space.

Each of the Multi-Protocol Performance Monitor units 29 in the example embodiment can be connected by the cross connect switch to any of the east or west network channels ports e.g. 124, 127 or any of the tributary receiver ports e.g. 24. This capability supports the benefits of WDM networks, being their ability to transport multiple protocols independently and without need for bit synchronisation between multiple channels.

For all monitoring applications, the data signal to be monitored is copied by the multi-cast cross-connect switch to the destination port(s) (tributary and/or network ports) and to a monitor port. The monitor CDR 33 associated with that port is configured for the required data rate.

It is generally required that used tributary ports be monitored 100% of the time in addition, the network ports are preferably also monitored. Thus, the number of performance monitors in the preferred embodiment is larger than the number of tributary ports. A single round-robin monitor can be used for the monitoring of the network ports, but more than one additional monitors may be provided for allowing simultaneous monitoring of two or more network ports.

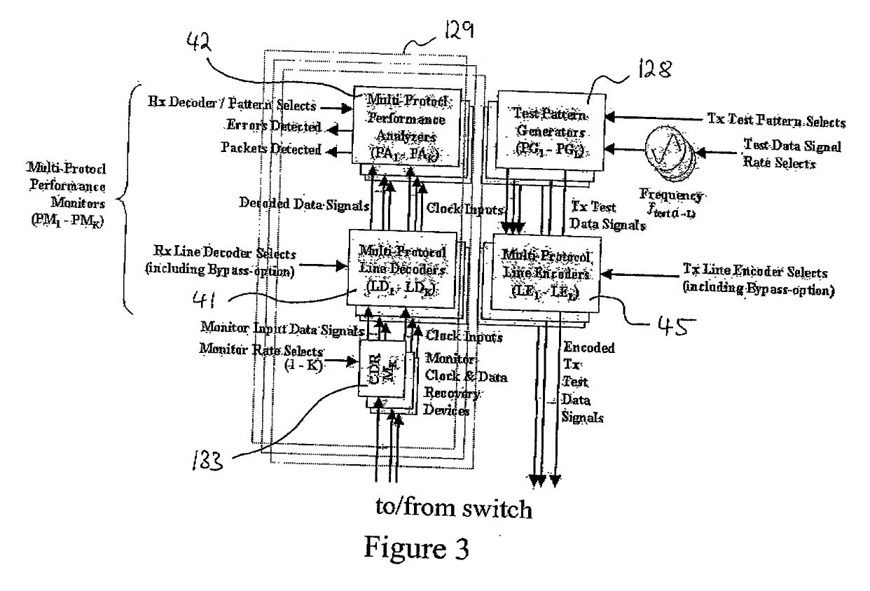

FIG. 3 shows an alternative embodiment. An example of an implementation of multi-protocol performance monitor units 129 is shown, each comprising a Multi-Protocol Line Decoder (MPLD) 41 and associated Multi-Protocol Performance Analyser (MPPA) 42 and a monitor CDR133.

In the case of non-intrusive performance monitoring of customer traffic, the retimed data and associated clock output of relevant monitor CDR 133 is supplied to the appropriate Line Decoder 41 that matches the customer data protocol. The received data stream is then decoded and the decoded data presented to the relevant protocol Performance Analyser 42. This may be a BIP-8 byte analyser and error counter in the case of SONET protocols or it may be a code-violation counter in the case of 4B/5B or 8/B/10 coded protocols such as Gigabit Ethernet.

In the case of intrusive performance monitoring of test signals generated locally or elsewhere (including standard external BERT test data patterns), the line decoder function may be bypassed and the test pattern sent directly to a simple pattern decoder. This pattern decoder and error counter function is included as part of the Performance Analyser 42 shown in FIG. 3.

For data-centric protocols such as Gigabit Ethernet and Fibre Channel, the performance analyser function may also provide packet monitoring features, such as packet rate, packet length and packet error rate (based on CRC errors).

FIG. 3 also shows an enhancement to the test generator function, being the addition of multi-protocol line encoders 45 for each test generator 128. Line encoders for a range of popular and standard protocols can be added to enable more thorough testing of network channels and tributary interfaces. As mentioned earlier, simple long-sequence (eg, 2²³-1) PRBS patterns may not be capable of testing specialised tributary interfaces designed for 8B/10 encoded signals. Additionally, some anomalies in the performance of wavelength channels may only become apparent for particular line codes and thus can only be diagnosed by emulating such line codes by the test signal generator.

As shown in FIG. 3, the line encoding function can be subjected to a standard raw test sequence, such as 2²³-1 PRBS patterns. In the case of a 8B/10R line encoder 45, this would remove the long strings of 1 s or 0 s in the raw test pattern. The line encoder 45 can be bypassed when not required eg, when testing channels and tributary interfaces provisioned for SONET-OCn.

Using matching line encoders 45 and decoders 41, it is possible to employ the performance monitoring function to intrusively monitor test generator and BERT patterns and to non-intrusively monitor customer traffic. This provides more efficient use of diagnostic test logic.

The embodiments described provide an improvement to the cross-connect switching and basic diagnostic testing by adding multi-protocol performance monitoring to additional ports on the cross connect switches. This then enables both tributary ports and through (network) traffic to be monitored. A preferred embodiment also enables intrusive diagnostic testing to be undertaken more thoroughly by adding multi-protocol line encoders to the test signal generators. The line encoders are programmed or selected to match to the characteristics of the tributary interfaces to be tested (using electrical or optical loop-back testing of the tributary ports for example). More thorough testing of supposedly protocol-agnostic wavelength channels can also be tested using this enhancement. The test data pattern generator for intrusive testing of unused paths and channels can be designed to emulate real encoded data patterns and data rates representative of each protocol. This then permits the non-intrusive performance monitors to be used for testing both used and unused paths and channels, thus better utilising or minimising the number of logic devices required.

Presently, it is envisaged that standard protocols and data rates would initially be supported (such as SONET OC-n and 8B/10B encoded data streams). However, through the appropriate use of high speed Serializer/Deserializer (SERDES) devices and multi-rate CDRs, it is feasible that almost any protocol could be specified and then monitored by a performance monitor implemented with micro-coded logic within a custom Very Large Scale Integrated (VLSI) device or Application Specific Integrated Circuit (ASIC), or as a Field Programmable Gate Array (FPGA). As new protocols emerge, the micro-code in the VLSI, ASIC or FPGA devices can be downloaded with the new performance monitoring functions.

In the case of FPGA based implementations and smaller OEO cross connect applications, it is feasible that the Multirate CDRs and Multi-Protocol Cross Connect switching functions could also be implemented in the same FPGA device as the multi-protocol performance monitoring and multi-protocol diagnostic testing functions.

The embodiments as described herein provide bit-error-ratio performance monitoring of the unused channels by the multi-protocol performance monitoring units. Once a channel is provisioned for a customer and the user data is to be connected, the test signals for intrusive monitoring can be removed by the cross-connect switching function and the customer traffic inserted in its place. This may require reconfiguring the data rate for the CDRs associated with that channel in order to match the data rate required by the customer's data. Data rates could very from, for example, 50 Mbit/s to 2.5 Gbit/s, covering a range of protocols including for example SONET OC1, OC3, OC12, OC48, Gigabit Ethernet, Fibre Channel, ESCON, 100BaseFX, D1 Video, High Definition TV etc.

Whilst the invention has been described with specific reference to a bi-directional ring network, it will be apparent to a person skilled in the art that the invention can also be applied to point-point, linear (bus) and mesh network topologies.

The types of tests that can be performed in embodiments of the invention include point-point and loop-back testing of channels within a network. With point-point testing, the test pattern generators and performance monitoring units may be located at separate nodes of the network. For loop-back testing, the test pattern generator and performance monitoring unit are located at the same node and loop-back is performed by a switch element elsewhere in the network.

It will be appreciated by the person skilled in the art that numerous modifications and/or variations may be made to the present invention as shown in the specific embodiments without departing form the spirit or scope of the invention as broadly described. The present embodiments are, therefore, to be considered in all respects to be illustrative and not restrictive.

In the claims that follow and in the summary of the invention, except where the context requires otherwise due to express language or necessary implication, the word “comprising” is used in the sense of “including”, i.e. the features specified may be associated with further features in various embodiments of the invention.

1. A diagnostic monitoring system for a WDM network, the system comprising:
an electrical non-blocking cross-connect switch having a plurality of demultiplexer ports, a plurality of multiplexer ports, at least one tributary receiver port, at least one tributary transmitter port, and at least one diagnostic port; and
at least one multi-protocol performance monitoring unit connected to one of said at least one diagnostic ports such that said at least one multi-protocol performance monitoring unit, in use, can selectively monitor one of said demultiplexer or tributary receiver ports;
whereby said system, in use, supports multi-protocol intrusive monitoring of a test signal and multi-protocol non-intrusive monitoring of live traffic at said at least one demultiplexer or tributary receiver port.

2. A system as claimed in claim 1, wherein the system comprises a group of multi-protocol performance monitoring units each connected to one of the diagnostic ports of said switch such that the multi-protocol performance monitoring units can monitor a plurality of demultiplexer and/or tributary receiver ports.

3. A system as claimed in claim 1, wherein said multi-protocol performance monitoring unit comprises a programmable clock and data retiming (CDR) element and a programmable multi-protocol monitor.

4. A system as claimed in claim 3, wherein said programmable multi-protocol monitor comprises at least one of Gigabit Ethernet, Fibre Channel or SONET OC-n protocol monitors.

5. A system as claimed in claims 3 or 4, wherein said programmable multi-protocol monitor comprises a programmable line decoder and a programmable performance analyser for non-intrusive performance monitoring of live customer traffic.

6. A system as claimed in claim 5, wherein, the multi-protocol monitoring unit further comprises a pattern decoder and error counter element, and is arranged, in use, such that the line decoder can be selectively bypassed for intrusive performance monitoring utilising the pattern decoder and error counter element.

7. A system as claimed in claim 1, wherein the system transfer comprises at least one programmable test signal generator unit connected to one of said diagnostic ports, such that said at least one test signal generator unit can input a test signal at one of said multiplexer or tributary transmitter ports for intrusive performance monitoring.

8. A system as claimed in claim 7, wherein the switch is arranged, in use, to support multi-cast of said one test signal to at least two of said multiplexer and/or tributary transmitter ports.

9. A system as claimed in claim 7 or 8, wherein said programmable test signal generator unit comprises a programmable line encoder for encoding said test signal.

10. A system as claimed in claim 9, wherein the line encoder is arranged such that it is by-passable.

11. A WDM network node comprising a diagnostic monitoring system as claimed in any one of claims 1, 2, 3, 4, 7, or 8.

12. A WDM network node as claimed in claim 11, wherein the WDM network node is arranged as a OEO WDM add/drop multiplexer or terminal multiplexer node, and the electrical non-blocking cross-connect switch of the diagnostic monitoring system is disposed such that, in use, switching of the WDM channel signals is effected through said electrical non-blocking cross-connect switch of the diagnostic monitoring system.

13. A network node as claimed in claim 12, wherein the OEO WDM add/drop multiplexer or terminal multiplexer node comprises 3R regeneration.
